(19) United States
(12) Patent Application Publication
(10) Pub. No.: US 2018/0130119 A1
(43) Pub. Date: May 10, 2018

(54) PRODUCT TAGGING AND PURCHASING METHOD AND SYSTEM

(71) Applicant: DGA, Inc., Boston, MA (US)

(72) Inventors: Damjan KORAC, Bethesda, MD (US); Gerrit OREM, Springfield, MA (US)

(73) Assignee: DGA, Inc., Boston, MA (US)

(21) Appl. No.: 15/808,299

(22) Filed: Nov. 9, 2017

Related U.S. Application Data
(60) Provisional application No. 62/420,074, filed on Nov. 10, 2016.

(51) Int. Cl. G06Q 30/06

(52) U.S. Cl. CPC G06Q 30/0635; G06Q 10/02

(57) ABSTRACT

Embodiments of the present disclosure includes a system and method for the purchase of goods on third-party websites. In one aspect, the method includes receiving a request of product information from a consumer; retrieving product information from retailers' online product catalogs; providing a single account on a publisher website for the consumer to make selections based on the product information; and allowing the consumer to execute a purchase of products across all retailer websites without leaving the publisher website.

### CROSS-REFERENCE TO RELATED APPLICATION

This application claims priority to and the benefit of U.S. Provisional Patent Application No. 62/420,074, titled “Product Tagging and Purchasing Method and System”, which was filed on Nov. 10, 2016 and is incorporated by reference herein in its entirety.

### FIELD

The present application relates generally to a method and system for ordering items on third-party websites.

### BACKGROUND

Online shopping has become a ubiquitous way for consumers to purchase products, and so-called “e-commerce” is on its way to match the volume of traditional brick-and-mortar shopping. The Internet has created the potential for retailers to provide a better experience for their customers. In fact, progress has been made in terms of fast shipping and a more streamlined user experience within retailer websites themselves. At the same time, third-party publisher sites (e.g. online magazines, blogs, social media posts, forums, etc.) have increasingly become a place for users to learn about products and discuss them. The growing importance of third-party publishers in driving consumer purchase behavior has the potential to bring considerable benefits to consumers, retailers, and publishers. By discovering new products in content they choose to view rather than on e-commerce sites or in display advertisements that appear based on their browsing activity, consumers enjoy greater autonomy over their web browsing experience. Retailers also benefit, as publishers represent a new marketing channel that allows them to reach consumers unobtrusively, on websites that these target consumers already enjoy. Finally, increased attention from consumers and retailers not only drive greater traffic toward publisher websites, but may also lead to the development of new technologies that help publishers create and monetize content more effectively. While the heightened importance of third-party content promises to benefit all three stakeholders, it also highlights some notable deficiencies in the current state of e-commerce. It is clear that there is a link between a consumer's web browsing experience (whether done through a browser, smartphone application, online video channel, or any other media through which a user may interact with content on the Internet) and their purchasing behavior.

The prior art has attempted to address the inability to link publisher influence and retail sales through the development of affiliate marketing and hyperlink platforms. This attempted solution is almost as old as e-commerce itself. In its current iteration, which remains fundamentally unchanged from the 1990s, a publisher may manually place a hyperlink to a retail site that either contains a unique identifying string in its URL or places a tracking cookie on a user's computer. If the user then completes a purchase on the retail site, the publisher is entitled to a commission from the retailer. This technology fails to adequately address the question of recognizing third-party publisher influence in consumer behavior and purchasing decisions. Technical deficiencies in the cookies system, privacy concerns causing consumers to routinely delete cookie files from their computers, the delay between a consumer interacting with content and completing the purchase, and the inability to directly connect a clicked link to a completed purchase all cause difficulties in correctly attributing a sale's influence. The opportunity for misattribution and fraud is so great that retailers have sued publishers and affiliate networks.

Any new solutions in recent years have attempted to improve the affiliate link system by making link management more straightforward and devising methods by which cookies can be recovered if lost, such as the method shown in US2014/0019266, titled “System and Method for Dynamic Management of Affiliate Links for Online Marketing”, which is filed Dec. 31, 2012, and claims the priority date of provisional application No. 61/617,857, filed on Mar. 30, 2012. They neither improve a consumer's user experience nor provide more data to publishers and retailers. The solutions of the past two decades only reveal that experienced players in the e-commerce technology industry are committed to affiliate link technology and improving it. Any developments have also ignored the fact that cookie-based affiliate networks do not translate to mobile browsers and apps for browsing content and making purchases.

### SUMMARY

Embodiments of the present disclosure includes a system and method generating a purchase order of a product on a publisher's website. In one aspect, the method can include outputting, by a processor, a product tag to a user; receiving, by the processor, an input of clicking the product tag from the user; retrieving, by the processor, information of the product based on the received input of clicking the product tag; providing, by the processor, an account on the publisher's website to the user to make a selection of an attribute of the product based on the retrieved information of the product; receiving, by the processor, a selection of the attribute of the product from the user; generating, by the processor, a purchase order based on the received selection; and outputting, by the processor, the generated purchase order.

In some embodiments, the method can include initiating a generation of a retailer purchase order in a back-end system of a retailer. In some embodiments, the method can include adding the generated purchase order to a queue to be retrieved electronically by a retailer. In some embodiments, the method can include generating a master purchase order and sending a portion of the master purchase order to at least one retailer. In some embodiments, the product can include one or more goods or services. In some embodiments, the one or more goods or services can include clothing, electronics, cosmetics, subscriptions, event tickets, travel bookings, home furnishings, venue reservations, food delivery services, groceries, restaurant reservations, vehicle rentals, collectibles, art, gift cards, pet supplies, or books.

The present disclosure also relates to a method of generating a product tag on a publisher's website. In one aspect, the method can include: receiving from a user, by a processor, an input of selecting a section of an image or video containing a product on the publisher's website; creating, by the processor, the product tag on the selected section of the image or video; and outputting, by the processor, the created product tag.

In some embodiments, the method can include receiving an input of information of the product from the user; identifying the product in a digital catalog based on the received input of information; and crating the product tag based on the identified product. In some embodiments, the information of the product can include a brand name, a product type, or a product name.

In some embodiments, the method can include receiving a uniform resource locator (URL) from the user; retrieving information of the product form a website of a retailer based on the received URL; and creating the product tag based on the retrieved information of the product.

In some embodiments, the method can include outputting a list of one or more products stored in an internal product catalog; receiving a selection from the list from the user; and creating the product tag based on the received selection from the user.

In some embodiments, the method can include identifying an affiliate link on the publisher's website; extracting information of the product based on the identified affiliate link; comparing the extracted information of the product to an internal product catalog; determining a match based on comparing the extracted information of the product to the internal product catalog; creating the product tag based on the determined match; and removing the identified affiliate link.

In some embodiments, the method can include determining a degree of certainty based on comparing the extracted information of the product to the internal product catalog; comparing the degree of certainty to a predefined threshold; and determining the match if the degree of certainty is higher than the predefined threshold.

In some embodiments, the method can include identifying a file hash of the image or video; extracting information of the product based on the identified file hash; comparing the extracted information to an internal product catalog; determining a match based on comparing the extracted information to the internal product catalog; and creating the product tag based on the determined match. In some embodiments, the product can include one or more goods or services. In some embodiments, the one or more goods or services can include clothing, electronics, cosmetics, subscriptions, event tickets, travel bookings, home furnishings, venue reservations, food delivery services, groceries, restaurant reservations, vehicle rentals, collectibles, art, gift cards, pet supplies, or books.

The present disclosure also relates to a system of generating a product tag on a publisher's website. In one aspect, the system can include a processor configured to execute instructions causing the processor to: receive from a user an input of selecting a section of an image or video containing a product on the publisher's website; create the product tag on the selected section of the image or video; and output the created product tag.

Other features and advantages can become apparent from the following detailed description and drawings.

### BRIEF DESCRIPTION OF THE DRAWINGS

In order to facilitate a fuller understanding of the present disclosure, reference is now made to the accompanying drawing, in which like elements are referenced with like numerals. These drawings should not be construed as limiting the present disclosure, but are intended to be illustrative only.

FIG. 1 depicts a flow chart of a product tagging and purchasing method in accordance with embodiments of the present disclosure;

FIG. 2 shows an exemplary publisher interface in accordance with embodiments of the present disclosure;

FIG. 3 shows an exemplary publisher interface for viewing details on an existing product tag in accordance with embodiments of the present disclosure;

FIG. 4 depicts a flow chart of three product tag creation methods in accordance with embodiments of the present disclosure;

FIG. 5 depicts a flow chart of Link Backfill method for product tag creation in accordance with embodiments of the present disclosure;

FIG. 6 shows an exemplary website interface with analytics for publishers in accordance with embodiments of the present disclosure;

FIG. 7 shows an exemplary consumer interface in accordance with embodiments of the present disclosure;

FIG. 8 depicts a block diagram of a system for routing orders to each retailer in accordance with embodiments of the present disclosure;

FIG. 9 shows exemplary product tags across media and devices in accordance with embodiments of the present disclosure;

FIG. 10 depicts a block diagram of two image tagging processes in accordance with embodiments of the present disclosure;

FIG. 11 depicts a block diagram of a system for product tagging and purchasing in accordance with embodiments of the present disclosure; and

FIG. 12 depicts a block diagram of an architecture of a product tag in accordance with embodiments of the present disclosure.

### DETAILED DESCRIPTION

Third-party publisher sites provides an access for consumers to learn and build interest in the products from retailers. The present disclosure describes a method and system that benefits all three stakeholders. For purposes of this disclosure, publisher is a person or organization that publishes content on websites or in applications, including, but not limited to online magazines, blogs, social media posts, forums, and smartphone applications. Consumer refers to a person who purchases products and services. Retailer is an entity that sells products or commodities directly to consumers. Consumers are able to purchase products of different retailers directly on third-party publisher websites via a single account and a single action; publishers are able to monetize their content while keeping the consumers on the publisher's page; retailers are able to acquire new customers and cut down on cart abandonment. A product tagging method and system is provided as a link between publisher content and retailer product, which enables the above benefits. In some embodiments, the product can include one or more goods or services. In some embodiments, the one or more goods or services can include clothing, electronics, cosmetics, subscriptions, event tickets, travel bookings, home furnishings, venue reservations, food delivery services, groceries, restaurant reservations, vehicle rentals, collectibles, art, gift cards, pet supplies, or books. In some embodiments, the product can include other goods or services.

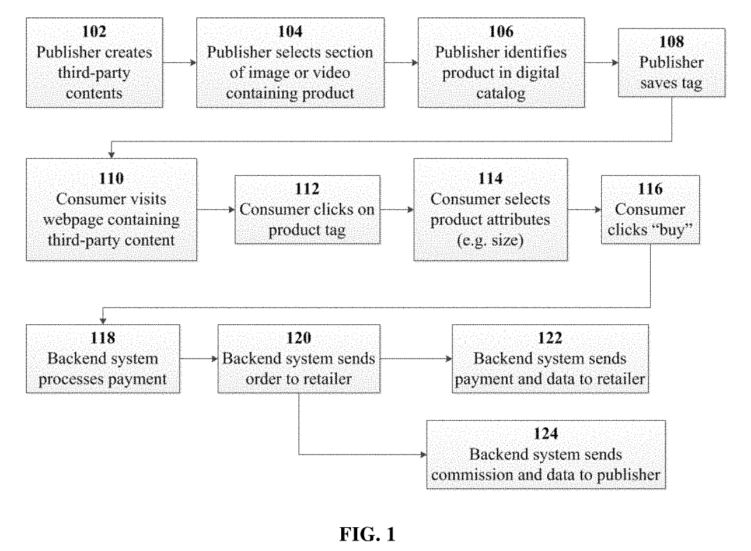

The system can contain separate functionality that may be used by publishers, consumers, and retailers. FIG. 1 depicts a block diagram of a product tagging and purchasing method in accordance with embodiments of the present disclosure. At a high level, the use of the system begins as publishers create third-party contents 102. A section of image or video containing the product are selected 104, products in digital catalog of retailer site are then identified 106. Connections are made between images and videos on publisher websites and specific products in retailer catalogs. These connections are created and saved as a series of product “tags” 108 which indicate precisely where in an image or video a given product exists. Consumers, for their part, may view these tags as they visit the publisher's website 110. By clicking on a given product tag 112, consumers may select and add the corresponding products 114 to a sidebar interface. The sidebar retrieves information on each product directly from the system's internal product catalog, which aggregates the data present in retailers' online product catalogs, websites, or any other direct or indirect method by which they communicate the list of products that they sell. Consumers add products to the sidebar interface as they browse the publishers' content and are able to complete purchases without needing to leave the page. Once a consumer clicks “buy” 116 and completes a purchase in the sidebar, the backend system processes the payment 118 and sends the relevant order details to the retailers 120 whose products were in the sidebar at the time of purchase. The system either automatically generates new orders in retailers' Order Management Systems (OMS), creates lists of new orders that are accessible to retailers, or injects orders using a simulated browser, at which point retailers accept ownership of order management. In the end, the payment and relevant data are sent to the retailer 122, the commission and relevant data are sent to the publisher 124. The payment is handled according to the specific contract with each retailer, including but not limited to either having the system process payment and send the total minus the commission to the retailer or having the entire payment get processed by the retailer, with the commission being sent afterwards. In addition to handling the saving of tags and processing of purchases, the system collects and transmits data that can help retailers and publishers refine their sales and monetization strategies.

### Publisher Interface

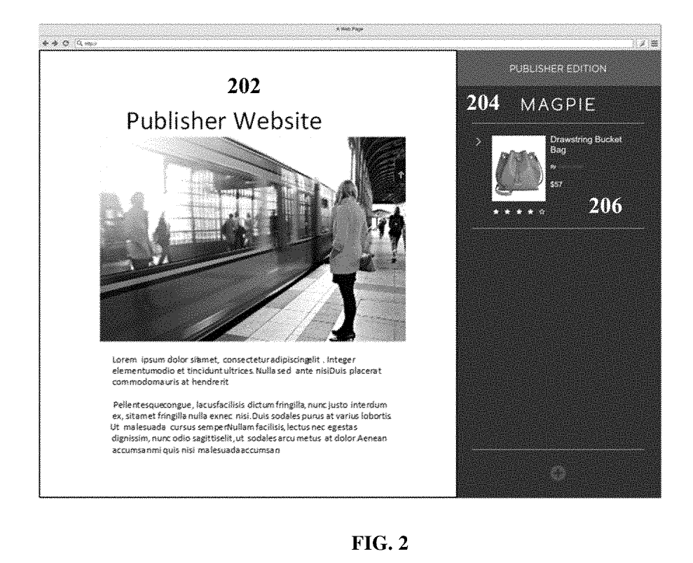

FIG. 2 shows an exemplary publisher interface of the system 200 in accordance with an embodiment of the present disclosure. In some embodiments, on the publisher website 202, the system can be accessible for publishers via a browser extension that publishers can download and install on their computer. When a publisher clicks on the system's browser extension icon, a sidebar interface 204 appears. This sidebar is the primary means by which publishers add new tags, remove existing tags, and view summary analytics about consumer actions. An existing tag 206 is shown in the sidebar interface. In addition to the browser extension and sidebar interface, publishers can use an account on the system's website to view more detailed analytics.

For example, when an online publisher views posts on her website 202, she can click the system's icon in the browser, the sidebar interface 204 appears. By default, the sidebar can show a list of all product tags 206 that the publisher has previously saved on that page. At this point, the publisher can take one of two actions: she can select an existing tag or create a new tag.

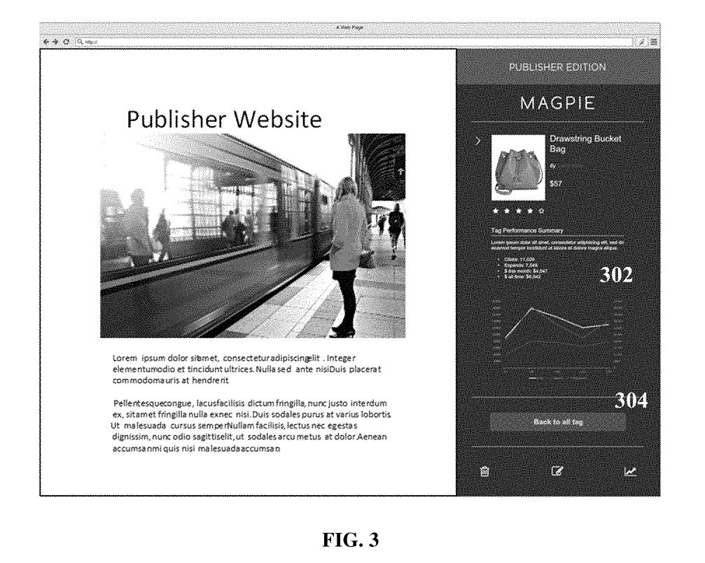

When the publisher clicks on an existing tag, the sidebar can show a new view 300 with additional details about the selected tag, as shown in FIG. 3. Here, the publisher can see summary analytics 302 about that tag's performance, including but not limited to the number of clicks and sales that the tag has generated since it was created. These summary statistics may be presented numerically as well as in graphical form. This single-tag view also enables the publisher to delete the tag, edit the product to which it is linked, and identify other products that consumers might want to purchase based on their interest in the tag. Finally, this view provides the publisher a link that takes her to the subpage within the system's website that provides more detailed analytics on that specific tag. Clicking “Back to all tags” 304 in this view takes the publisher back to the default sidebar state, which can display all tags on the current page.

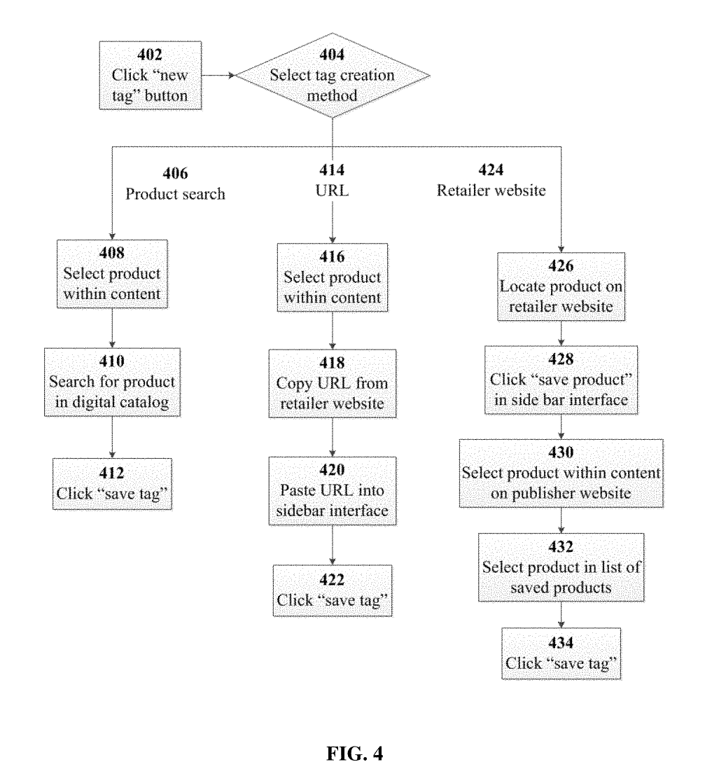

Publishers can have several options for adding new tags to their content. FIG. 4 depicts a block diagram of three product tag creation methods that can be completed manually by the publisher. The first two options let publishers add tags directly to content on their website while the third enables them to begin the tag creation process from a product page on a given retailer's website. While the first three methods are all completed manually by the publisher in the sidebar interface, the fourth option enables the publisher to automatically convert existing product hyperlinks to the system tags. The four tag creation methods can include Add by Product Search 406, Add by Uniform Resource Locator (URL) 414, Add on Retailer Website 434, and Link Backfill.

In some embodiments, Add by Product Search 406 method can be used. In this method, publishers begin by clicking a “new tag” button 402 within the sidebar interface, which gives the publishers the choice of selecting tag creation method 404. In the case of image tags, they are then prompted to select the region of an image containing the product being tagged. In the case of video tags, they are prompted to select both the playback time(s) and the region where the desired product appears. From there, publishers manually enter information about the product in the sidebar using a series of text entry fields until the correct product has been identified 410. For example, publishers type the name of the brand that produces the product, the type of product being tagged (e.g. shoes versus handbags), and the product name. In each case, the system can auto-complete the text being entered based on the product catalogs of the retailer partners in the system's database. Once the appropriate product has been identified, publishers view a preview of the tag that consumers can see before saving the tag. Finally, publishers click a “save tag” icon 412. At this point, the tag has been saved and is viewable by consumers visiting the page.

In other embodiments, Add by Uniform Resource Locator (URL) 414 method can be used. In this method, publishers begin by clicking a “new tag” button within the sidebar interface. In the case of image tags, they are then prompted to select the region of an image on the page containing the product 416 being tagged. In the case of video tags, they are prompted to select both the playback time(s) and the region where the desired product appears. Rather than entering product information manually, this method lets publishers to copy the URL from retailer website 418 and enter the URL of the retailer webpage 420 containing the desired product. Once the URL has been entered, publishers can view a preview of the tag that consumers can see. Finally, publishers click a “save” icon 422. At this point, as in the other method, the tag has been saved and is viewable by consumers visiting the page.

In certain embodiments, Add on Retailer Website 424 method can be used. In this method, publishers begin the tag creation process directly by locating product on retailer website 426. When viewing the page containing the desired product, publishers click “save product” in side bar interface 428 and select product within content on publisher website 430. Publishers select product in a list of saved products 432 and click the “new tag” button in the sidebar interface. Then “save tag” button is clicked 434 and the product on that page is then added to a list of “in progress” tags. Upon returning to their website, publishers can initiate the creation of a tag from this list.

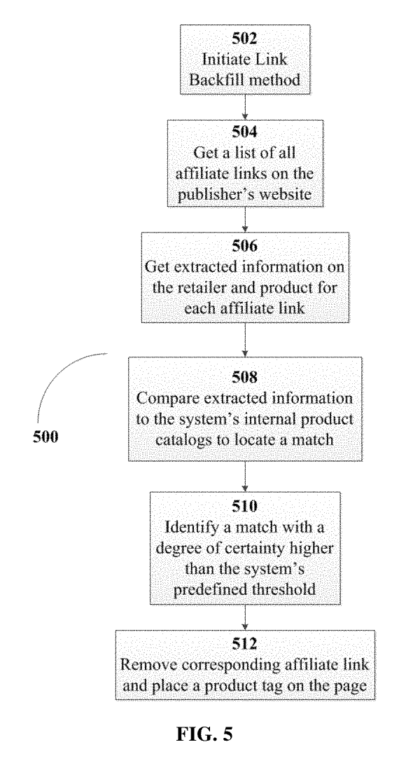

In other embodiments, a Link Backfill method can be used. FIG. 5 depicts a flow chart of a Link Backfill method 500. The prior three methods of adding tags require publishers to manually create individual tags. By contrast, this method can automatically convert existing hyperlinks to retailer product pages into the system product tags. Each system product tag created by this method can be associated with the product to which each hyperlink points. Rather than creating tags one-by-one, this method enables publishers to initiate the conversion of all product hyperlinks simultaneously. In some embodiments, the system itself can initiate the Link Backfill method. To provide a practical example, a hypothetical publisher can use the Link Backfill method in the following way. First, publisher logs into their account on the system's website and clicks a button that initiates the Link Backfill method 502. The system builds a list of all affiliate links 504 currently on the publisher's website. To accomplish this, the system navigates through each page on the publisher's website, inspects elements on the page, and looks for a hyperlinks that contain a string matching one of the domain names used by affiliate networks. For each affiliate link in the list, the system analyzes the destination landing page to extract information on the retailer and product 506. Again, the system can accomplish this data extraction by inspecting elements on the page for metadata such as item ID, retailer name, product name, department, and category. In some embodiments, the file name of the image or video on the publisher's website can be used to extract information of the product. The system can compare the file name with the image or video files on the retailer's website or digital catalog to identify the product, and then extract related product information. The system can compare the extracted product data 508 to the system's internal product catalogs to locate a match. This comparison is accomplished primarily using two methods. First, the system can store a library of the ways in which major online retailers organize data on their website. Using this information, the system can match the product to one in the system's internal catalog with a degree of certainty higher than the system's predefined threshold 510. Second, the system can use pattern matching algorithms to compare data retrieved from the publisher's website to data in the system's internal product catalog. For instance, the system can search its internal product catalog for products with a retailer matching the string “Retailer X” and an item id matching the integer 1234. The system might also use more sophisticated algorithms; for instance, the system might look for “partial” matches and use a scoring system to estimate the likelihood of certainty for each product match. For each product match found with a degree of certainty higher than the system's predefined threshold, the system can remove the corresponding affiliate link from the publisher's website and place a product tag on the page in its place 512. For example, if the system compares two products and finds a Hamming distance less than 2 when comparing product images and also finds that the product names share 12 out of 13 characters, the system can categorize the two products as a “strong match” to indicate a high likelihood of them being the same product. The system can automatically categorize potential product matches into buckets indicating the likelihood of an exact match, and will automatically convert affiliate links to “strong match” products into the system's product tags. In some cases, the system can use image recognition algorithms to associate the product tag with a region of a specific image on the page; in other cases, the product tag can simply be associated with the page in general.

In all four methods, the system is retrieving data from retailer product catalogs in order to help publishers quickly identify the correct product. In addition to product data, the system can give publishers access to the commission offered for each product during the tagging process. These data may be retrieved directly from retailers' back-end OMS via application program interfaces (APIs), from periodically updated copies of retailer catalogs saved in the database, or by any other method of accessing the retailer's product list.

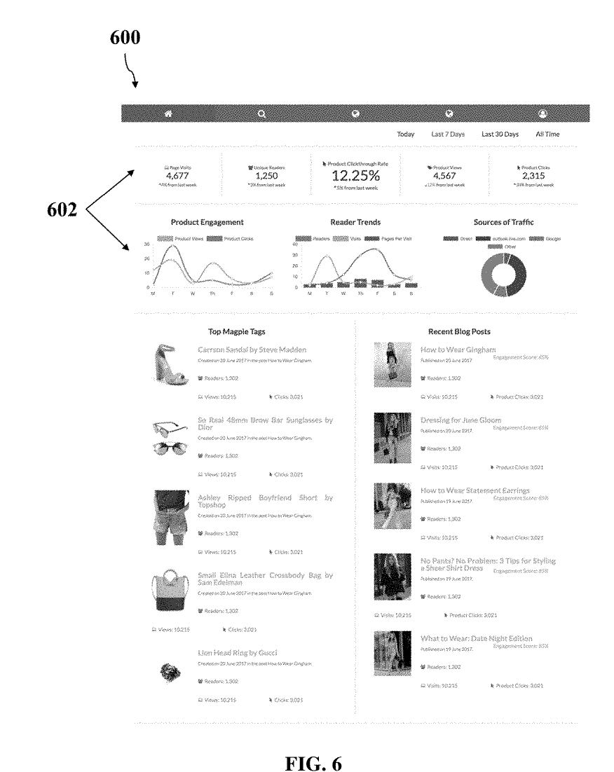

Publishers can also view more detailed data analytics outside of the sidebar interface. A given publisher accesses this information by logging into their account on the system's website. FIG. 6 shows an exemplary website interface 600 with analytics 602 for publishers in accordance with an embodiment of the present disclosure. There, data can be made available to them in both a highly granular form as well as aggregated by various parameters. The website can contain data visualizations that can be filtered and aggregated on demand. Additionally, publishers can download both the granular and aggregate data in comma-separated values (CSV) format.

Examples of the data available to publishers include, but are not limited to, number of times consumers clicked a given tag to add it to the sidebar; number of times consumers expanded a given tag in the sidebar for more information; length of time a given tag remained in the sidebar before being removed; sales dollars by month or all time generated by a given tag; commission earned for a given tag; number of times consumers clicked a link in the sidebar that took redirected them to the retailer website; and return rate for a given tag. In some embodiments, other data can be analyzed and shown to publishers. As shown in the exemplary website interface in FIG. 6, such data can include number of page visits, number of unique readers, product click-through rate, number of product views, number of product clicks, product engagement, reader trends, or sources of traffic, etc.

Publishers can also aggregate each of these data points by one or more parameters including, but are not limited to:
Timeframe, for example, the number of times consumers clicked tags for products from a specific brand from December 2016 to February 2017;
Retailer, for example, the dollar value of sales generated by each retailer;
Brand/designer, for example, the dollar value of sales generated by each brand;
Marketing campaign, for example, the number of times consumers clicked tags that correspond to a given marketing campaign initiated by a retailer;
Product type, for example, are sunglasses selling more frequently through the system than designer handbags;
Product price, for example, how much more frequently, if at all, are lower-ticket items selling than more expensive items;
Geographic origin of purchase, for example, are more sales dollars being generated in Florida than in Oregon;
Publisher style/type, for example, are publishers who write about luxury goods generating more sales than publishers focused on cheaper goods; and
Custom metadata field. the system can also provide publishers the ability to report out on custom parameters that they set themselves, either during the product tagging process or by using additional data from the retailer's Order Management Systems (OMS).

### Customer Interface

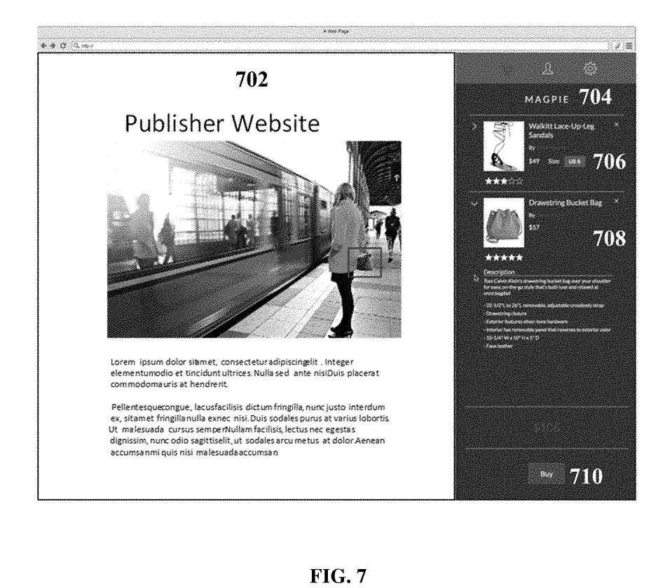

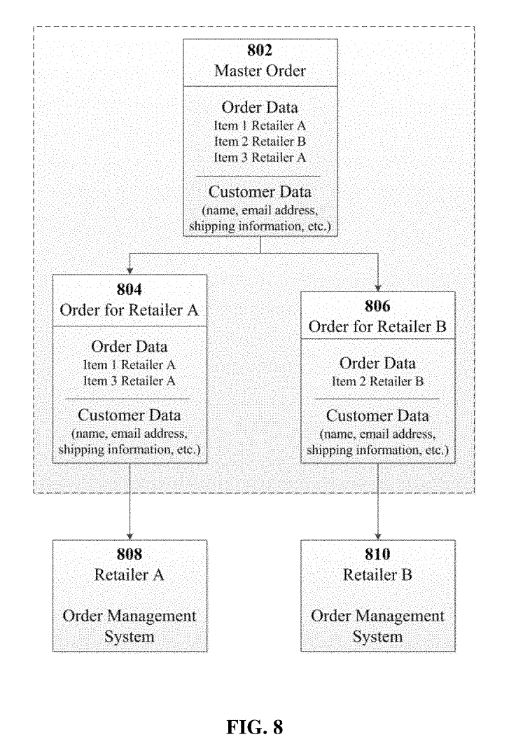

By registering with the system, consumers gain the ability to use a single account to complete purchases on any third-party publisher website or application that uses the software. When a consumer visits a page containing tags created through the system, they are able to interact with those tags without needing to download any additional software: consumers simply click on tags in order to add the products to the sidebar interface, where they may view additional details and complete purchases. In some embodiments, other purchase interfaces can be used by the consumer. For example, if the user is browsing the website on a mobile device, a purchase interface can be invoked by swiping the display in a certain direction. Let us now walk through the process a consumer follows in order to complete purchases. FIG. 7 shows an exemplary consumer interface in accordance with an embodiment of the present disclosure, wherein a consumer is viewing two products 706 & 708 using the side bar interface 704 on the publisher website 702.

Consider the example of a consumer browsing his favorite fashion blog 702. He navigates to a new post and sees an outfit that catches his interest. In this example, the publisher has already created product tags in a picture of the outfit by previously using the system. There are several ways for a consumer to identify tags including, but are not limited to, hovering over individual parts of the image or seeing an icon right beside the image that upon click reveals that there are items tagged. These indicators let consumers find the system tags quickly without being too visually obtrusive.

When the consumer clicks on a given tag, the product appears in the sidebar interface. Information about the product is retrieved either from the system's databases or directly from the retailers' back-end systems and is shown to the consumer. This information includes but is not limited to the product name, description, price, retailer and/or brand offering the product, average rating, available sizes, available colors, and one or more sample images. By default, only a subset of this information is shown to the consumer. However, the consumer also has the option of clicking a button in the sidebar that reveals the more detailed product information.

Once a given product has been added to the sidebar, the consumer has several options. He can, for example, remove the product from the sidebar by clicking the “X” icon next to the product. He also has the option of selecting a size, color, and/or other parameters, depending on the type of product. Finally, he can opt to buy the product by clicking “Buy” 610 within sidebar 604. Upon choosing to buy the product, the system sends the consumer an email confirming his purchase through the system and sends his order information to the appropriate retailer. From this point on, the retailer takes ownership of the consumer's order and his experience is identical to what he would see had he purchased the product directly on the retailer's e-commerce store: he can receive an email from the retailer confirming his order and can coordinate with the retailer for any questions related to shipping and handling.

The example above describes how a hypothetical consumer might purchase a single product through the system. He can also use the system to purchase multiple products simultaneously, even if those products are sold by different online retailers. The process is essentially the same: the consumer clicks on multiple tags to add the products to the sidebar, selects sizes and color as appropriate, and clicks “Buy.” At this point, the system separates the consumer's cart into multiple orders based on the retailer offering each item, and sends each order to the appropriate retailer. From the customer's perspective, the process is the same as what he would have experienced had he purchased only one product, except that he can receive an email from each retailer involved in his purchase.

It is important to point out that the examples above describe the most common scenario: one in which the consumer has already registered with the system and is logged in upon arriving at the third-party publisher's website. Once a consumer registers with the system for the first time, he never needs to enter login credentials again, unless he clears his browser's cookies. Having a system account offers consumers other benefits as well: the system not only remembers consumers' favorite sizes, colors, and styles at specific stores, but also uses data analytics to suggest the best sizes, colors, and fits when consumers shop with a given brand for the first time. However, it is important to note that the first time a consumer tries to purchase products through the system, he needs to complete a registration process.

If a consumer has not yet registered with the system, his experience can be as follows. He can still see the icon indicating that a given image contains the system's product tags. When he clicks on the tags, he can also pull them into the sidebar interface and view product information. When he clicks “Buy”, however, the sidebar can prompt him to enter shipping and payment information. Once he completes the registration process, his purchases can be processed as normal. Additionally, a cookie can be added to his computer so that the system recognizes him the next time he visits a website using the software.

### Retailer Interface

Retailers primarily interact with the system by receiving payments for products purchased through the system. They can also use the system to view analytics on the performance of their publisher partners and the anonymized browsing behavior of consumers. A given retailer accesses these data by logging into their account on the system's website. There, data can be made available to them in both a highly granular form as well as aggregated by various parameters which help identify large-scale trends and refine sales strategies. The website can contain data visualizations that can be filtered and aggregated on demand. Additionally, retailers can download both the granular and aggregate data in comma-separated values (CSV) format.

Examples of the data available to retailers include, but are not limited to, number of times consumers clicked a given tag to add it to the sidebar; number of times consumers expanded a given tag in the sidebar for more information; length of time a given tag remained in the sidebar before being removed; number of orders generated by a given tag; sales dollars generated by a given tag; number of times consumers clicked a link in the sidebar that took redirected them to the retailer website; and return rate for a given tag.

Retailers can also aggregate each of these data points by one or more parameters including, but are not limited to:
Timeframe, for example, the number of times consumers clicked tags created by a specific publisher from December 2016 to February 2017;
Publisher, for example, the dollar value of sales generated by each publisher;
Marketing campaign, for example, the number of times consumers clicked tags that correspond to a given marketing campaign initiated by a retailer;
Product type, for example, are sunglasses selling more frequently through the system than designer handbags;
Product price, for example, how much more frequently, if at all, are lower-ticket items selling than more expensive items;
Geographic origin of purchase, for example, are more sales dollars being generated in Florida than in Oregon;
Publisher style/type, for example, are publishers who write about luxury goods generating more sales than publishers focused on cheaper goods; and
Custom metadata field, the system can also provide retailers the ability to report out on custom parameters that they set themselves, either during the product tagging process or by using additional data from the retailer's OMS.

### Other Architecture

The present disclosure defines a unique workflow and methods for handling orders that are made on third-party publisher sites. In one aspect, they initially appear as a single transaction for consumers but are actually passed to the relevant retailers, who process as distinct transaction. Depending on the type of order, it can appear on a consumer's credit card statement—or other transaction log for a different payment method—as a single payment to the system or as multiple individual payments to each retailer whose products are contained in the order. This design makes more efficient the process by which a user discovers a product order and is able to successfully purchase it from the appropriate retailer.

In another aspect, the disclosure explicitly defines the mechanism by which these orders are routed to each retailer, as shown in FIG. 8. FIG. 8 depicts a block diagram of a system through which the orders are routed to each retailer in accordance with embodiments of the present disclosure. All items in dashed area are enclosed in the described system. Any links outside of this rectangle are to external systems. First, an internal Master Order 802 is generated based on a user's input on the page and submission of necessary payment and shipping information (whether that is manually defined or automatically generated based on account information or historical data). The Master Order can include both Order Data and Customer Data. Order Data can include Item 1 from Retailer A, Item 2 from Retailer B, and Item 3 from Retailer A. Customer Data can include, but are not limited to, name, email address, and shipping information. The order—with all of the contained items, regardless of the retailer—is stored as a single transaction. Second, the items within the order are grouped by retailer. Two exemplary retailers are used in FIG. 8, including Order for Retailer A 804 and Order for Retailer B 806. Order for Retailer A can include Order Data and Customer Data. The Order Data can include Item 1 from and Item 3. Order for Retailer B can include Order Data and Customer Data. Here, the Order Data can include Item 2. In both instances, the Customer Data can include, but are not limited to, name, email address, and shipping information. Orders for three or more retailers can also be operated in the presently disclosed system. The Order for Retailer A and Order for Retailer B are then separated out into a unique order per retailer, with each one containing all necessary consumer information to complete the transaction, as well as metadata on the order. Third, each order (data and payment) is passed to the OMS of Retailer A 808 and the OMS of Retailer B 810, respectively. The present disclosure depicts a system that is robust to handle any type of retailer e-commerce system, website, order management system, and any other technology that may be used in completing a transaction from order placement to item shipment. As a result, the system contains multiple methods of sending an order to a retailer, and the list is non-exhaustive.

The method described in the present disclosure can communicate an order to a retailer in the following ways, including, but not limited to API integration with brand catalogs, messaging queue (pull from retail side), automated site/form manipulation, manual ordering, and/or file/database updates.

In API integration with brand catalogs, whenever an order occurs, the system immediately makes an API call to a retailer system and allows for native order processing; In messaging queue (pull from retail side), all relevant orders are immediately pushed onto a messaging queue, and retailers use their own system (whether through routine scripts, listening worker bots, or any other similar implementation of a “listener” method) to process orders. They are removed from the queue as soon as the retailer system acknowledges their receipt; in automated site/form manipulation, for retailers that do not provide any form of direct integration, the system can fulfill orders directly on retailer websites or apps by automatically inputting the relevant order data in all necessary forms and submitting the order as if a human being had clicked all of the buttons (ranging from “Add to Cart” buttons on product description pages to inputting address information at checkout). the system has methods in its back-end servers to mimic human website or app behavior, and orders are placed without a graphical interface ever being opened in front of a live person; in manual ordering, a human manually sends the order to the retailer via an e-commerce site, email, or phone call; in file/database updates, the system updates a specific file (such as a .csv) or database table with new orders, and the retail system is set to watch the locations for changes. When an order is successfully noticed and fulfilled, then the relevant record is either actually erased or “soft deleted,” with a flag set to indicate the success or failure of the intended transaction.

In all order fulfillment methods, the commission to the system—and any relevant transaction costs—is either immediately extracted from the order payment (with the system forwarding price minus commission to the retailer) or accomplished through retroactive attribution (with the system passing along all order money minus the transaction fees to the retailer and getting paid for all successful orders at the end of a given time period, such as the last day of the month).

### Product Tags and Image Architecture

The present disclosure introduces the concept of a product tag, which is fundamentally a visual indicator in or around media to indicate the presence of an item. The media include, but are not limited to image, photo, video, and animation. In the case of images, the tag appears as a monochromatic rectangle over the product; and an indicator may or may not appear in the corner of the image or at one side (flush in terms of height or width with the tag) to more easily show a consumer that something has been tagged. The shape of the indicator includes, but is not limited to, a triangle, chevron within a circle, or any other shape that has the ability to point in a specific direction. In a basic case, a publisher may have a photo of a face with sunglasses. A user can see a rectangle around the sunglasses when hovering over the photo and click on it to activate the sidebar interface and purchase it. Tags can appear in a similar manner for video and smartphone application content, although the manner in which a consumer “clicks” on them may be different. Furthermore, for videos the tags can be accessed when content is paused, or after it has finished playback. For the purposes of this disclosure, situations involving a tag in a photo are assumed; but it is important to point out that all embodiments can also extend to tags in other types of media.

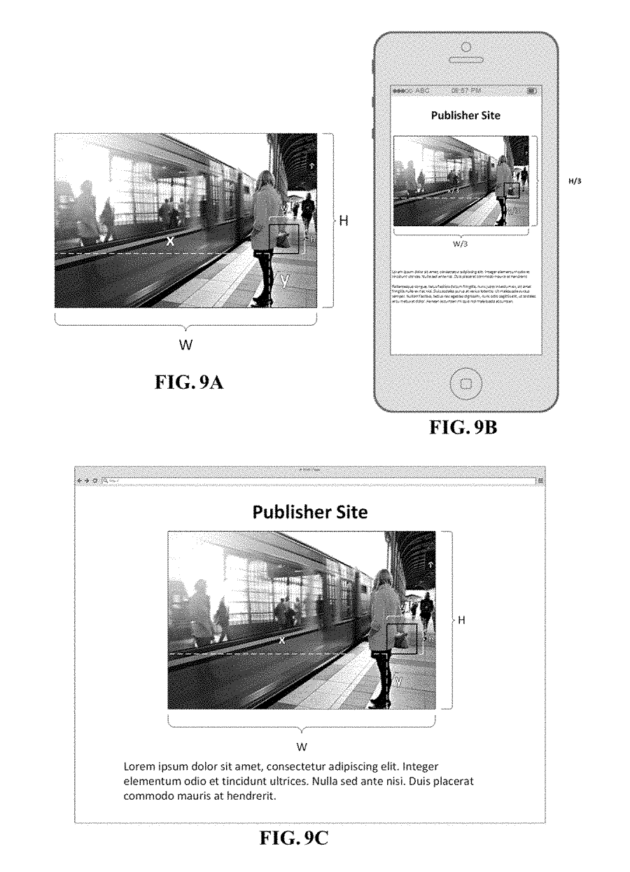

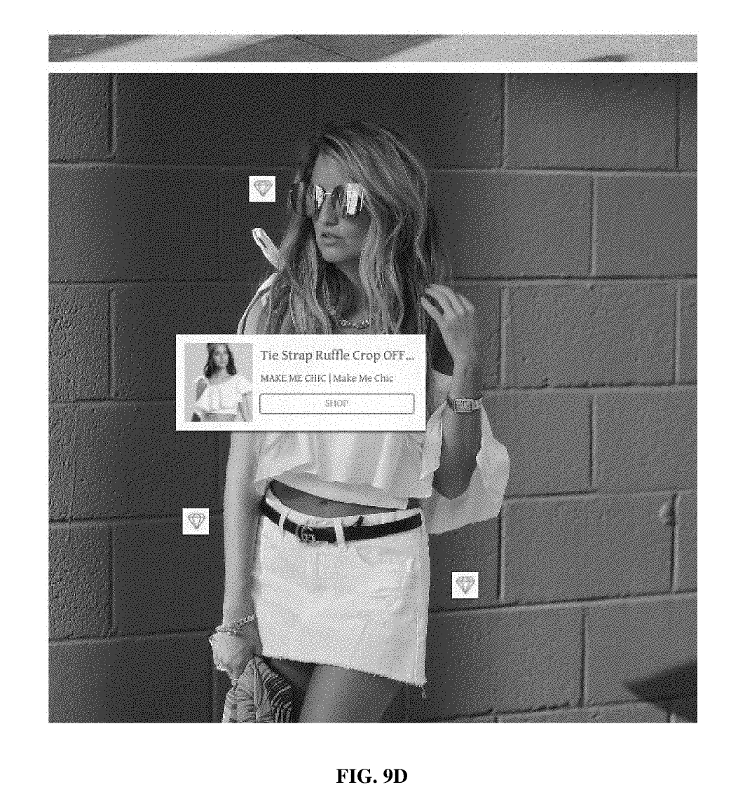

Each tag can be device- and application-agnostic, and FIG. 9 shows exemplary product tags across media and devices in accordance with embodiments of the present disclosure. FIG. 9A shows an original image with a height H and width W from which a product tag can be created. This tag can be dynamically re-sized and re-positioned based on how the image appears on various devices. The devices showing the tags in this disclosure can include, but are not limited to a desktop, laptop, cellphone, tablet, and workstation. The tags can appear either within browsers or non-browser applications, including social media platforms and messaging software. In one embodiment, FIG. 9B shows a smartphone displaying the tag, resized with a height H/3 and width W/3. In another embodiment, FIG. 9C shows a desktop browser displaying the tag with the original size. FIG. 9D shows exemplary image tags on a publisher's website.

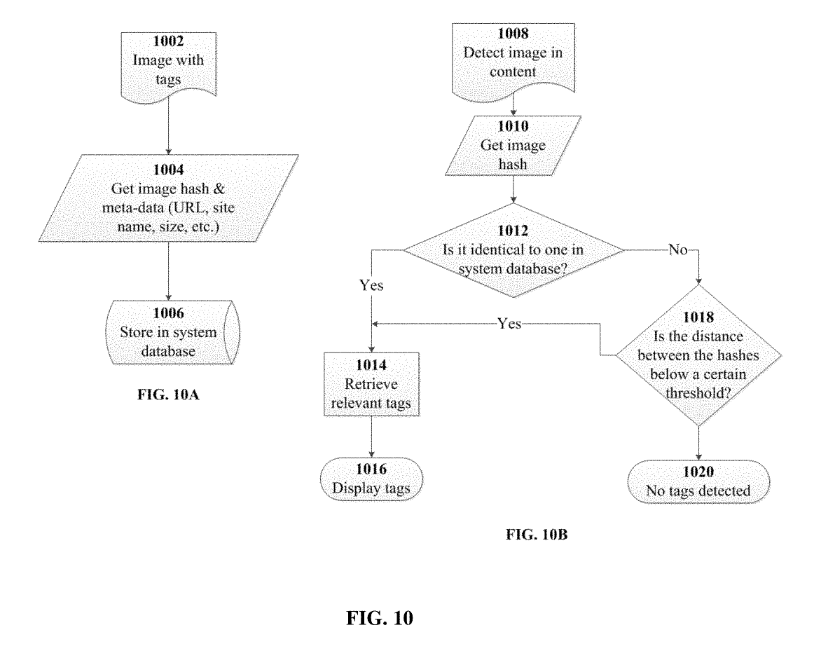

Whenever a new tag is created for a product-image pair, image data are collected to serve as a dictionary for future comparisons, as shown in FIG. 10A. The image with tag 1002 can be stored in a database and properly linked to entries in the product catalog. All relevant image hash and meta-data 1004—including, but not limited to, post URL, title, date, keywords in content on the page, and the image itself—can be stored in system database 1006, as well as the width, height, and Cartesian coordinates (assuming that the corner of the image serves as the origin point). These data not only provide more context to publishers and retailers about the tag, but also allow the system to properly re-size and re-position the tag whenever the image appears on a page, even if a user has adjusted the size of the web page or zoom levels. The Cartesian (x, y) coordinates and width-height ratio allow for proper re-scaling with the tag still over the product, no matter which device or browser and application is used. A publisher may—for example—tag a product on their desktop browser, and the system can translate that tag to properly indicate the same product in the image when it later appears on a smartphone browser.

Furthermore, the system can process the images with tag when a tag is created and store additional information, including an image hash, all detected edges, and pixel and color statistics. When products with an image has been tagged once, the products with the image can be detected any other time that it appears on a website (assuming that some sort of the system software is running on the website's server, or on the client-side device). When the tag appears on the original site in which it was created, the system can use the URL and specific page content to detect that the image has tags. However, it can also detect tags when the identical or substantially similar image appears in any other site by relying on the stored image hash and other image analysis data.

When an image is encountered in content, tags are identified if it is identical or very similar to an existing tagged image in the system. FIG. 10B depicts a block diagram of the detailed process by which the system determines which tags to place on an image that is either identical or very similar to an already tagged one. When an image 1008 is encountered in content, image hash 1010 is generated to for a determination step 1012 on whether it is identical to one in system database. A sample image hashing algorithm that is used is a perceptual hash generated by turning the image to grayscale, reducing the size, and then concatenating pixel values to produce a unique image identifier. When there is an identical image hash in the system database, relevant tags are retrieved 1014 and the tags are displayed 1016. In the case that no identical image hash is found in the system databased, another determination step 1018 is performed on whether the distance between the hashes is below a certain threshold. By relying on previously-stored image hash and other analysis data, the system can determine whether an image is similar to another one. The threshold similarity may be about 99%, or about 98%, or about 95%, or about 90%, or about 85%, or about 80%. In a specific embodiment of the disclosure, if there is 98% similarity based on distance between the hashes, the image is considered similar. In that situation, other features of the image can be examined to determine the tags. For example, a publisher completes a photo shoot with several different angles of the same outfit. If only one photo is explicitly tagged, then the system can use image comparison algorithms to determine that the other photos contain the same products from that photoshoot. The accuracy of predicted product tags depends on the similarity of the photos and number of objects in the media that are not the actual human model and clothing. If considered similar, the relevant tag retrieving process 1014 is performed to for display. When the similarity value is below the threshold, no tags are detected 1020.

The system also allows for “assisted” or “smart” tagging in which image features are used to predict—with varying levels of specificity—the product type being tagged. In this case, image features are products or specific parts of a person's body; and the system using image description algorithms to learn how to identify portions of an image. For example, it can know that a region of an image contains a person's feet. When a user tags a product in that region, then the system predicts that the tagged product is of the category “shoe” or “footwear” and suggest relevant products from the system database to the user, thereby saving time and effort for the user.

### Product Catalog and Database

The present disclosure defines methods for creating and maintaining an up-to-date catalog of all retailer products, including but not limited to price, description, and availability. This feature provides a benefit to both publishers and consumers as the former is able to easily add any available product to their content through the aforementioned product interface, while the latter can instantly see whether the item they want to purchase is available at the retailer. In both instances, the involved parties do not need to leave their current workflow in order to check directly with a retailer or find the information on any other website.

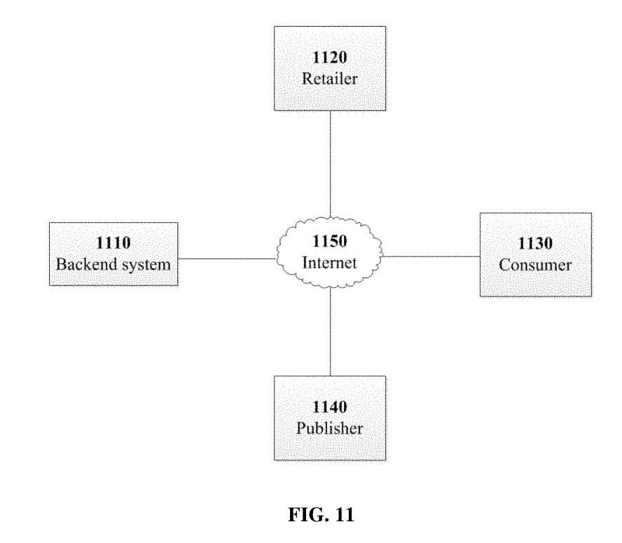

FIG. 11 depicts a block diagram of how backend system 1110 functions between retailer 1120, consumer 1130, and publisher 1140 through the Internet 1150. Internet 1150 can be the global system of interconnected computer networks via specific communication protocols. It can be network of networks including private, public, academic, business, and government networks, linked by a broad array of electronic, wireless and optical networking technologies.

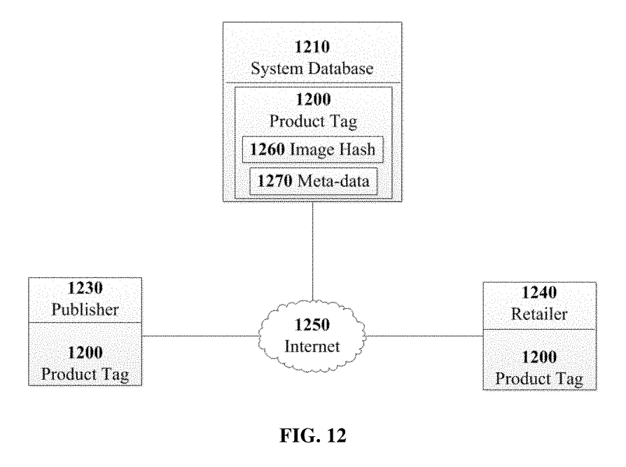

Product tag, as shown in FIG. 12, is an important feature that enabled the function of the backend system in the present disclosure. Once a product tag 1200 is created, the relevant image hash 1260 and meta-data 1270 are stored in system databased 1210. The meta-data can include, but not limited to, text content keywords, URL, and page title. A link between publisher 1230 and retailer 1240 is established via Internet 1250. Because of this link in the backend system, consumers are retained on the publisher website, and the purchase process can be finished on the publisher website without being transported away. The present disclosure represents an advancement of the current state of prior art as a database is product-oriented and defines a one-to-many relationship between a product and retailers (if it is sold by more than one store) and a one-to-many relationship between products and tags in content. For the latter, each product is linked to individual tags that highlight it in content, as well as meta-data about the image and post associated with the tag, including but not limited to text content keywords, URL, page title, etc. As a result, a retailer has access to more useful data concerning users' interactions with a given product across all publisher sites; and a publisher can browse and tag products by focusing on the item itself or its brand, instead of needing to commit to a specific retailer.

The product-oriented nature of the database enables a degree of flexibility that benefits both consumers and publishers. At a high level, the system consolidates the product catalogs of all participating retailers to create a “master” product catalog, while maintaining an up-to-date record of the various retailers who may carry each product. When a publisher tags a product, he may select a product from the master catalog rather than being required to specify a particular retailer, greatly simplifying the tagging process. Because tags are associated with products but not directly with retailers, the system can use business logic to automatically route orders to the appropriate retailer. This business logic may follow a variety of rules; for instance, it may maximize publisher commission, offer consumers the lowest possible price, or be designed to avoid stockouts. Consumers benefit from this data structure, as the system has the ability to handle price comparison and avoid stockouts without manual intervention.

The data structure design both allows for a publisher to update which retailer is linked to a specific product (in a specific tag) based on changing commissions and allows the system to automatically update which retailer receives an order if a specific store is sold out of a product, thereby minimizing any potential “down-time” for a tag and inconvenience to a consumer looking to purchase an item immediately. A publisher can be alerted to changes in product availability at a retailer, but the system also supports automatically re-routing an order away from the originally chosen retailer if a publisher has not yet taken action based on the “sold out” notification. For example, a consumer may decide to purchase a shirt from a tag which is linked to retailer A, the system can determine availability and discover that A does not currently have any of the shirt in the user's sizing, and then—based on the already-established preferences of the publisher who owns the tag—order the shirt or a similar one from retailer B. Once A has re-stocked the product, then orders for the shirt can resume being routed to A's order management system (or whatever other order-pushing method has been established with that particular retailer). In this specific example, retailer A is notified of every purchase attempt that was not fulfilled due to inventory scarcity.

Depending on both the sophistication of a retailer's e-commerce system and the nature of the integration with the system described in this disclosure, there are several methods to update the catalog database including, but not limited to, direct integration, API calls, and website/catalog scraping.

For direct integration, the system utilizes read access to retailer databases, catalogs, and/or other technical systems to maintain up-to-date records of all products; for API calls, API calls to retailer systems are utilized to create new catalog entries and update existing ones in the system. The calls occur at recurring, scheduled times or are triggered by publisher and consumer actions (such as a consumer trying to purchase a product with a database entry that has not been updated in the past few hours). In some cases, certain, less-often-updated data (such as product image and description) can be cached in the system's database, while more frequently updated information (such as current price and availability) is still accessed more directly by querying a retailer system. In website/catalog scraping, the system can utilize an automated “scraper” to regularly browse a retailer website, app, or other online location for product information and updates. This method primarily utilizes tags and object id's in HyperText Markup Language (HTML)/Cascading Style Sheets (CSS)/JavaScript code to identify information fields but can also rely on predictive machine learning techniques to attempt to extract information from sites that have not yet been directly added as the system partners. For example, a scraper knows to look for “Price:” in the HTML code of a partner retailer's product listing page. At the same time, the scraper knows to generally look for permutations of “price” that are near a currency symbol as it attempts to build a catalog of online products that are sold by retailers who are not yet official partners.

Lastly, in the present disclosure, the system can update tags when a product is no longer carried (due to seasonal fashion changes, outdated models, or any other reason). Both a publisher with active tags for the product—and the retailer that originally stocked the product—are notified. the system suggests similar products so that the tags can be updated and minimize frustration and confusion for the consumer. For example, if a black shirt from retailer A is no longer produced, then the product catalog updating process can suggest replacement products to all publishers that currently have a tag with that specific product. Logic for the replacement product includes in some cases giving preference to another shirt from the same exact retailer A, or a comparable black shirt regardless of the retailer. For these recommendations, the system can make a decision by weighing aggregated data on consumer purchasing behavior, specific product features, characteristics of photos and posts containing the product, and information from the retailer itself.

### Advantages of the Backend System in the Present Disclosure

The system represents a significant and untapped market opportunity. Enabling consumers to purchase directly from third-party content using a single account across all websites on the internet can help retailers acquire new customers and grow online sales. Publishers can also enjoy significantly greater conversion rates, due to the ease with which their readers can purchase. The system also offers both retailers and publishers a wealth of data that can help them refine their strategies and increase sales further. Finally, consumers can enjoy a fundamentally smoother online shopping experience.

The system's approach to connecting consumers, publishers, and retailers has several key benefits for each stakeholder.

1. Consumer Benefits:

By meeting consumers where they are and enabling them to complete purchases directly from publisher content, the system creates a more seamless integration between web browsing and shopping. This way, online shopping becomes easier for consumers as they use their single account through the system across the entire internet to complete purchases without having to leave the page. Additionally, consumers enjoy greater privacy than is possible with affiliate marketing's cookie-based approach.

2. Publisher Benefits:

The system enables publishers to monetize their content more effectively by helping them raise conversion rates and consumer basket sizes. By providing multiple easy options for quickly tagging products, the system also provides publishers more time to create content. Because consumers can complete purchases without leaving a publisher's page, they remain on the website longer and thus have more opportunities to buy. Additionally, the system lets consumers buy goods from multiple retailers simultaneously with a single action, without needing to create accounts with those retailers. The system also lets publishers avoid the pitfalls of cookie-based monetization solutions, which make it possible for other affiliates to overwrite their cookies on consumers' machines. Finally, and perhaps most importantly, publishers can benefit by virtue of the better user experience their readers can enjoy with the system.

3. Retailer Benefits:

The system offers retailers a powerful tool for acquiring new customers. By providing online consumers a way to seamlessly complete purchases as they browse third-party content, the system helps ensure customers can have a positive first experience with a given retailer. The system can not only enable retailers to acquire new customers and cut down on cart abandonment, but also help them avoid the fraud associated with affiliate marketing. Finally, the system offers retailers a wealth of data that can help them better understand in influence that online publishers command.

In addition to directly benefiting the three groups of stakeholders listed above, the system also has the potential to benefit the e-commerce ecosystem as a whole. The affiliate link approach to monetizing third-party content, having gone largely unchanged since its inception, is archaic, prone to fraud, and creates a bad user experience online. The system represents a viable alternative to both affiliate links and obtrusive display advertisements. In this sense, the system is a step forward to a significantly more modern online experience.

The present disclosure is not to be limited in scope by the specific embodiments described herein. Indeed, other various embodiments of and modifications to the present disclosure, in addition to those described herein, can be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art can recognize that its usefulness is not limited thereto and that the present disclosure may be beneficially implemented in any number of environments for any number of purposes.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube), LED (light emitting diode) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method of generating a purchase order of a product on a publisher's website, the method comprising:
outputting, by a processor, a product tag to a user;
receiving, by the processor, an input of clicking the product tag from the user;
retrieving, by the processor, information of the product based on the received input of clicking the product tag, wherein the product comprises one or more goods or services;
providing, by the processor, an account on the publisher's website to the user to make a selection of an attribute of the product based on the retrieved information of the product;
receiving, by the processor, a selection of the attribute of the product from the user;
generating, by the processor, a purchase order based on the received selection; and
outputting, by the processor, the generated purchase order.

2. The method of claim 1, wherein outputting the generated purchase order comprises:
initiating a generation of a retailer purchase order in a back-end system of a retailer.

3. The method of claim 1, wherein outputting the generated purchase order comprises:
adding the generated purchase order to a queue to be retrieved electronically by a retailer.

4. The method of claim 1, wherein generating the purchase order of the product comprises:
generating a master purchase order; and
sending a portion of the master purchase order to at least one retailer.

5. The method of claim 1, wherein the one or more goods or services comprise clothing, electronics, cosmetics, subscriptions, event tickets, travel bookings, home furnishings, venue reservations, food delivery services, groceries, restaurant reservations, vehicle rentals, collectibles, art, gift cards, pet supplies, or books.

6. A method of generating a product tag on a publisher's website, the method comprising:
receiving from a user, by a processor, an input of selecting a section of an image or video containing a product on the publisher's website, wherein the product comprises one or more goods or services;
creating, by the processor, the product tag on the selected section of the image or video; and
outputting by the processor, the created product tag.

7. The method of claim 6, wherein creating the product tag on the selected section of the image or video comprises:
receiving an input of information of the product from the user;
identifying the product in a digital catalog based on the received input of information; and
creating the product tag based on the identified product.

8. The method of claim 7, wherein the information of the product comprises a brand name, a product type, or a product name.

9. The method of claim 6, wherein creating the product tag on the selected section of the image or video comprises:
receiving a uniform resource locator (URL) from the user;
retrieving information of the product from a website of a retailer based on the received URL; and
creating the product tag based on the retrieved information of the product.

10. The method of claim 6, wherein creating the product tag on the selected section of the image or video comprises:
outputting a list of one or more products stored in an internal product catalog;
receiving a selection from the list from the user; and
creating the product tag based on the received selection from the user.

11. The method of claim 6, wherein creating the product tag on the selected section of the image or video comprises:
identifying an affiliate link on the publisher's website;
extracting information of the product based on the identified affiliate link;
comparing the extracted information of the product to an internal product catalog;
determining a match based on comparing the extracted information of the product to the internal product catalog;
creating the product tag based on the determined match; and
removing the identified affiliate link.

12. The method of claim 11, wherein determining the match based on comparing the extracted information of the product to the internal product catalog comprises:
determining a degree of certainty based on comparing the extracted information of the product to the internal product catalog;
comparing the degree of certainty to a predefined threshold; and
determining the match if the degree of certainty is higher than the predefined threshold.

13. The method of claim 6, wherein creating the product tag on the selected section of the image or video comprises:
identifying a file hash of the image or video;
extracting information of the product based on the identified file hash;
comparing the extracted information to an internal product catalog;
determining a match based on comparing the extracted information to the internal product catalog; and
creating the product tag based on the determined match.

14. The method of claim 6, wherein the one or more goods or services comprise clothing, electronics, cosmetics, subscriptions, event tickets, travel bookings, home furnishings, venue reservations, food delivery services, groceries, restaurant reservations, vehicle rentals, collectibles, art, gift cards, pet supplies, or books.

15. A system of generating a product tag on a publisher's website, the system comprising:
a processor configured to execute instructions causing the processor to:
receive from a user an input of selecting a section of an image or video containing a product on the publisher's website, wherein the product comprises one or more goods or services;
create the product tag on the selected section of the image or video; and
output the created product tag.

16. The system of claim 15, wherein the instructions further causes the processor to:
receive an input of information of the product from the user;
identify the product in a digital catalog; and
creates the product tag based on the identified product.

17. The system of claim 15, wherein the instructions further cause the processor to:
receive a uniform resource locator (URL) from the user;
retrieve information of the product from a website of a retailer based on the received URL; and
create the product tag based on the retrieved information of the product.

18. The system of claim 15, wherein the instructions further cause the processor to:
output a list of one or more products stored in an internal product catalog;
receive from the user a selection from the list; and
create the product tag based on the received selection.

19. The system of claim 15, wherein the instructions further cause the processor to:
identify an affiliate links on the publisher's website;
extract information of the product based on the identified affiliate link;
compare the extracted information to an internal product catalog;
determine a match based on comparing the extracted information to the internal product catalog;
create the product tag based on the determined match; and
remove the identified affiliate link.

20. The system of claim 15, wherein the instructions further cause the processor to:
identify a file hash of the image or video;
extract information of the product based on the identified file hash;
compare the extracted information to an internal product catalog;
determine a match based on comparing the extracted information to the internal product catalog; and
create the product tag based on the determined match.
